(19) United States
(12) Patent Application Publication
(10) Pub. No.: US 2009/0170500 A1
(43) Pub. Date: Jul. 2, 2009

(54) RADIO APPARATUS AND RADIO COMMUNICATION METHOD

(75) Inventors: Shigeo Terabe, Hachioji-shi (JP); Yutaka Asanuma, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 12/166,349

(22) Filed: Jul. 2, 2008

(30) Foreign Application Priority Data
Dec. 26, 2007 (JP) 2007-335289

(51) Int. Cl. H04Q 7/20; H04M 1/00

(52) U.S. Cl. 455/423; 455/561

(57) ABSTRACT

A controller selects M resource blocks having most preferable CQI values from Ncqi resource blocks on the basis of the reception signal qualities of the Ncqi resource blocks measured by a reception signal quality measuring unit. The controller then obtains the position information of the M resource blocks and the average of the M resource blocks, and outputs them as items of CQI information to a CQI channel generator. When performing best-effort data communication, the controller sets parameter M=Ma. When performing low-rate communication with a small delay, the controller sets parameter M=Mb (=Ncqi−Ma) to perform scheduling with a high degree of freedom.

### CROSS-REFERENCE TO RELATED APPLICATIONS

This application is based upon and claims the benefit of priority from prior Japanese Patent Application No. 2007-335289, filed Dec. 26, 2007, the entire contents of which are incorporated herein by reference.

### BACKGROUND OF THE INVENTION

1. Field of the Invention

The present invention relates to a radio apparatus used for a mobile communication system, e.g., a cellular phone.

2. Description of the Related Art

In a conventional radio communication system employing the adaptive modulation, the mobile terminal measures radio channel quality of a base station having a most desirable reception signal quality, and transmits the channel quality information to the base station, and the base station determines a transmission format (i.e., combination of the modulation, the coding rate, and the transmission power) which can be received by the mobile terminal, on the basis of the value of the channel quality information. Alternatively, the mobile terminal determines a receivable transmission format on the basis of the value of the measurement result, and transmits the transmission format information to the base station. At this time, feedback information which is transmitted to the base station is called the channel quality indication (CQI).

The base station then switches transmission formats for data to be transmitted to the mobile terminal on the basis of the CQIs obtained by the mobile terminal, and transmits transmission information via a dedicated control information channel. That is, the base station can schedule the above transmission at a transmission rate having an error tolerance adaptive to the receiving condition of the mobile terminal.

When there are a plurality of resource units which the base station is to assign to the mobile terminal, the mobile terminal measures the CQI of each resource and notifies the base station of the measurement result. For example, a system employing orthogonal frequency division multiplexing access (OFDMA) as a radio access scheme can perform communications by simultaneously using many sub-carriers. This system therefore divides the system band into blocks each comprising a plurality of continuous sub-carriers and assigns the resource block units to the respective mobile terminals, thereby switching transmission formats.

A transmitting station (base station) assigns resources, of a plurality of resources, which have preferable channel qualities to a plurality of mobile terminals, i.e., the respective receiving stations, thereby improving the throughput of each receiving station. The overall throughput of the system can be improved by causing a transmitting station to preferentially assign downlink data transmission resources to receiving stations of a plurality of receiving stations which are in relatively better receiving environments (refer to, for example, A. Japali, R. Padovani and R. Pankaj, “Data Throughput of CDMA-HDR, a High-Efficiency, High-Data-Rate Personal Communication Wireless System”, IEEE International Conference, VTC, Spring 2000).

As the number of resources which a transmitting station can assign to a receiving station increases, the signaling overhead associated with CQI transmission from the receiving station to the transmitting station poses a more serious problem. In order to solve this problem, various CQI information compressing techniques have been considered (refer to, for example, R1-073933, Mitsubishi Electric, “Selection of CQI reporting scheme”, 3GPP TSG RAN WG1 #50 bis).

For example, according to a CQI information compressing technique of a type that selects M CQI values from resource numbers and simultaneously notifying the position information of them, like the Best M average scheme, the optimal M value (the number of resources which transmit CQI values) which maximizes the system throughput varies depending on the type of communication service, the moving speed of a receiver, and a channel environment. As the M value changes, however, the information amount of a resource position changes, resulting in variations in the amount of CQI information. This poses the following problems.

When the size of a physical channel used for CQI transmission is fixed, as the amount of CQI information varies, it is impossible to achieve matching with a predetermined CQI information transmission resource size. When the size of a physical channel used for CQI transmission is fixed to the maximum value of the amount of CQI information, resources are steadily wasted. If the above size is fixed to an average amount of CQI information, as the amount of CQI information exceeds the fixed size, it is necessary to assign a new CQI information transmission resource. In addition, both a receiving station and a transmitting station need to recognize the amount of CQI information by some method. This generates a new signaling overhead.

Conventionally, in order to switch the number of resources for the transmission of CQI values in accordance with a service or the like, a transmitting side and a receiving side need to make an arrangement with each other concerning CQI resource information (sub-carriers by which a mobile terminal transmits CQIs to a base station, a CQI format, a modulation scheme, and the like) corresponding to the number of resources in advance.

### BRIEF SUMMARY OF THE INVENTION

The present invention has been made to solve the above problems, and has as its object to provide a radio apparatus and radio communication method which make it unnecessary for a transmitting side and a receiving side to make an arrangement on the above CQI resource information in advance even if the number of resources for the transmission of CQI values is switched.

To achieve this object, the present invention is a radio apparatus executing radio communication with a base station device accommodated in a network. The mobile radio terminal comprises a measurement unit measuring reception signal qualities of preset N radio resources a detection unit detecting that a preset event has occurred, and a notification unit notifying the base station device of identification information of M (M<N) radio resources, of N radio resources, from which preferable reception signal qualities are measured, on the basis of reception signal qualities of the N radio resources measured by the measurement unit, and, when the detection unit detects occurrence of the event, notifying the base station device of identification information of N−M radio resources, of the N radio resources, from which preferable reception signal qualities are measured, on the basis of the reception signal qualities of the N radio resources measured by the measurement unit.

As described above, the present invention is configured to notify a base station device of the identification information of M (M<N) radio resources, of N radio resources, from which preferable reception signal qualities are measured, on the basis of the reception signal qualities of the N radio resources. Upon detecting the occurrence of an event, the present invention is configured to notify a base station device of the identification information of N−M radio resources, of the N radio resources, from which preferable reception signal qualities are measured, on the basis of the measured reception signal qualities of the N radio resources when the occurrence of an event is detected.

According to the present invention, therefore, there can be provided a radio apparatus and radio communication method in which since the number of items of identification information of radio resources to be notified to a base station device is M or N−M, the information amount remains constant, and a transmitting side and a receiving side need not make an arrangement on the above CQI resource information even if the number of resources for the transmission of CQI values is switched.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIGS. 1A and 1B are views for explaining switching control of CQI notification by a radio apparatus according to the present invention;

FIG. 2 is a view showing an example of band assignment for the dedicated control information channels of a radio communication system according to the present invention;

FIG. 3 is a circuit block diagram showing a configuration of a receiver (mobile terminal) in the radio communication system according to an embodiment of the present invention;

FIG. 4 is a circuit block diagram showing a configuration of a transmitter (base station) in the radio communication system according to the embodiment of the present invention;

FIG. 5 is a sequence chart for explaining the operation of the radio communication system according to the first embodiment of the present invention;

FIG. 6 is a sequence chart for explaining the operation of the radio communication system according to the second embodiment of the present invention;

FIG. 7 is a sequence chart for explaining the operation of the radio communication system according to the third embodiment of the present invention;

FIG. 8 is a sequence chart for explaining the operation of the radio communication system according to the fourth embodiment of the present invention; and

FIG. 9 is a sequence chart for explaining the operation of the radio communication system according to the fifth embodiment of the present invention.

### DETAILED DESCRIPTION OF THE INVENTION

An embodiment of the present invention will be described below with reference to the views of the accompanying drawing. The embodiment to be described below exemplifies a case in which the number of resources which a base station (transmitting station) can assign to a mobile terminal (receiving station) is represented by N (N>1), and each measures the channel qualities of the N resources, selects M (M<N) channel qualities from them, and transmits the selected qualities as items of channel quality indicator (CQI) information to the base station. Assume that CQI information which the mobile terminal transmits to the base station contains a resource number for identifying the resource. The embodiment also exemplifies a case in which the Best M average scheme is used as a CQI information compressing technique.

The Best M average scheme selects M resources having preferable CQI values from Ncqi resources which can be assigned, and transmits the average of the M CQI values and values corresponding to M items of resource position information. If, for example, the average of CQI values is five bits, the amount of CQI information can be represented by the following formula (1).

$$5 + ⌈ {log}_{2} ( \begin{matrix}Ncqi \\ M\end{matrix} ) ⌉ \qquad ( 1 )$$

In a CQI compressing scheme of a type that notifies resource position information like the Best M average scheme, the optimal M value (the number of resources which transmit CQI values) varies depending on the type of communication service, the moving speed of a receiver, and a channel quality environment.

For example, a mobile terminal A which is to perform best-effort data communication (e.g., file downloading) can expect to perform high-throughput communication by notifying the base station of only a resource number corresponding to a high reception signal quality even though the delay increases. That is, Ma=2 for Ncqi=8.

In contrast to this, a mobile terminal B which is to perform low-rate communication with a small delay (e.g., retransmission of a Voice over Internet Protocol [VoIP] packet) preferably notifies the base station of many resource numbers corresponding to certain channel qualities to allow the base station to perform scheduling with a high degree of freedom. That is, Mb=6 for Ncqi=8.

As described above, the M value varies as the type of communication performed by a mobile terminal varies at each time point. If Ma+Mb=Ncqi holds, the amount of CQI information represented by the formula (1) remains the same regardless of the M value.

That is, even if the M value is switched from Ma to Mb (=Ncqi−Ma) (or switched inversely) in accordance with the type of communication service, the amount of CQI information remains the same. The present invention has paid attention to this point, and is configured to stabilize the amount of CQI information to be transmitted from a mobile terminal to a base station.

A radio communication system according to an embodiment of the present invention employs the OFDM modulation scheme. In the OFDM modulation, high-speed data signals are converted into low-speed narrow-band data signals, which are transmitted in parallel with a plurality of sub-carriers on a frequency axis. In this embodiment, the OFDM is composed of six-hundred sub-carriers with a sub-carrier distance of 15 kHz, as shown in FIG. 2. Twenty-four bands (resource blocks) are assigned to the dedicated control information channels and each band is composed of twenty-five sub-carriers, as shown in FIG. 2.

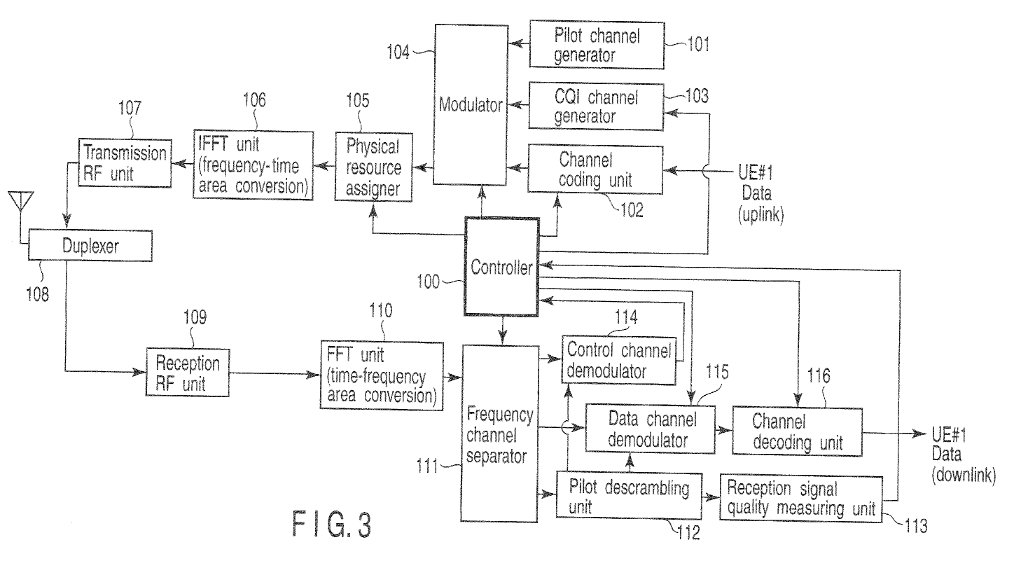

FIG. 3 shows a configuration of a receiving station (mobile terminal) of a radio communication system according to the first embodiment of the present invention.

A pilot channel generator 101 generates a bit string which is an original signal of a pilot signal to be transmitted over a pilot channel, processes the bit string with a scrambling code and outputs the bit string to a modulator 104. A CQI channel generator 103 generates a bit string of CQI information to be notified from a controller 100, and outputs the bit string to the modulator 104. The CQI channel generator 103 can also execute channel coding of the CQI information. A channel coding unit 102 executes channel coding of an uplink transmission data bit string at a channel coding rate designated by the controller 100 and outputs the channel codes to the modulator 104.

The modulator 104 generates a pilot signal, a CQI signal and a transmission data signal by subjecting the bit strings which are the original signals of the pilot signal, the CQI information and the channel-coded uplink transmission data signal, to digital modulation such as quadrature phase shift keying (QPSK) in a modulation scheme designated by the controller 100.

The generated pilot signal and transmission data signal are assigned to respective sub-carriers designated by the controller 100, by a physical resource assigner 105. To “assign signals to sub-carriers” means to add a sub-carrier index representing positions on a time axis and a frequency axis, of the sub-carriers in the corresponding resource block, to signals represented by complex numbers.

An inverse fast Fourier transformation (IFFT) unit 106 converts a signal of the frequency area output from the physical resource assigner 105 into a signal of the time area, which is converted into a radio-frequency (RF) signal by a transmission RF unit 107 comprising a digital-to-analog converter, an up-converter, a power amplifier, etc. The RF signal is emitted into space, toward the base station, via a duplexer 108 and an antenna.

A radio signal transmitted from the base station is received at the antenna, and output to a reception RF unit 109 via the duplexer 108. The received radio signal is converted into a baseband digital signal by a reception RF unit 109 comprising a down-converter, an analog-to-digital converter, etc.

A fast Fourier transformation (FFT) unit 110 executes fast Fourier transformation of the baseband digital signal and thereby divides the signal of the time area into signals of the frequency area, i.e., signals of the respective sub-carriers. The signals thus divided for the respective sub-carriers are output to a frequency channel separator 111.

The frequency channel separator 111 separates the signals divided for the respective sub-carriers into a pilot signal, a control channel signal and a data signal in accordance with the designation of the controller 100.

The pilot signal is descrambled by a pilot descrambling unit 112, in a descrambling pattern opposite to a scrambling pattern employed in the base station which transmits the signal to be received by the mobile terminal. The descrambling result is output to a control channel demodulator 114, a data channel demodulator 115 and a reception signal quality measuring unit 113. On the basis of the pilot signal, the reception signal quality measuring unit 113 measures the reception signal quality of each of the Ncqi resource blocks. These measurement results are output to the controller 100.

A control channel demodulator 114 processes the control channel signal output from the frequency channel separator 111, by channel equivalence using the pilot signal descrambled by the pilot descrambling unit 112 and then demodulates the signal. The control channel bit string thus demodulated is output to the controller 100.

The controller 100 controls all the units of the mobile terminal. On the basis of the information included in the control channel, the controller 100 determines whether or not the receive signal is a signal transmitted for the own mobile terminal, for each sub-frame. If the controller 100 determines that the receive signal is a signal transmitted for the own mobile terminal, the controller 100 extracts signaling information included in this signal, and detects information which is necessary for demodulation of the data channel signal and information which is necessary for decoding of the data channel signal, from the signaling information.

The information which is necessary for demodulation of the data channel signal is output to the data channel demodulator 115, while the information which is necessary for decoding of the data channel signal is output to the channel decoding unit 116. If the controller 100 determines that the receive signal is not a signal for the own mobile terminal, the demodulation or decoding of the data channel signal is terminated.

The data channel demodulator 115 processes each signal output from the frequency channel separator 111 by the channel equivalence using the pilot signal output from the pilot descrambling unit 112, and then demodulates the signal in the demodulation scheme designated by the controller 100, on the basis of the information output from the controller 100. The data bit string thus demodulated is decoded by the channel decoding unit 116, and the downlink data bit string for the own mobile terminal is thereby obtained. The information output from the controller 100 is used for the decoding.

The controller 100 performs adaptive modulation control in communication with the base station. The controller 100 employs, for example, the Best M average scheme as a CQI information compressing scheme. The controller 100 therefore determines the type of service to be executed in accordance with, for example, a request from the user via a user interface (not shown), and switches the number M of CQIs to be notified to the base station in accordance with the determination result.

The controller 100 then selects M resource blocks having most preferable CQI values from the Ncqi resource blocks on the basis of the reception signal qualities of the Ncqi resource blocks which are measured by the reception signal quality measuring unit 113, obtains the position information of the resource blocks (the above resource position information) and the average of the CQI values of the M resource blocks, and outputs the obtained items of information as items of CQI information to the CQI channel generator 103.

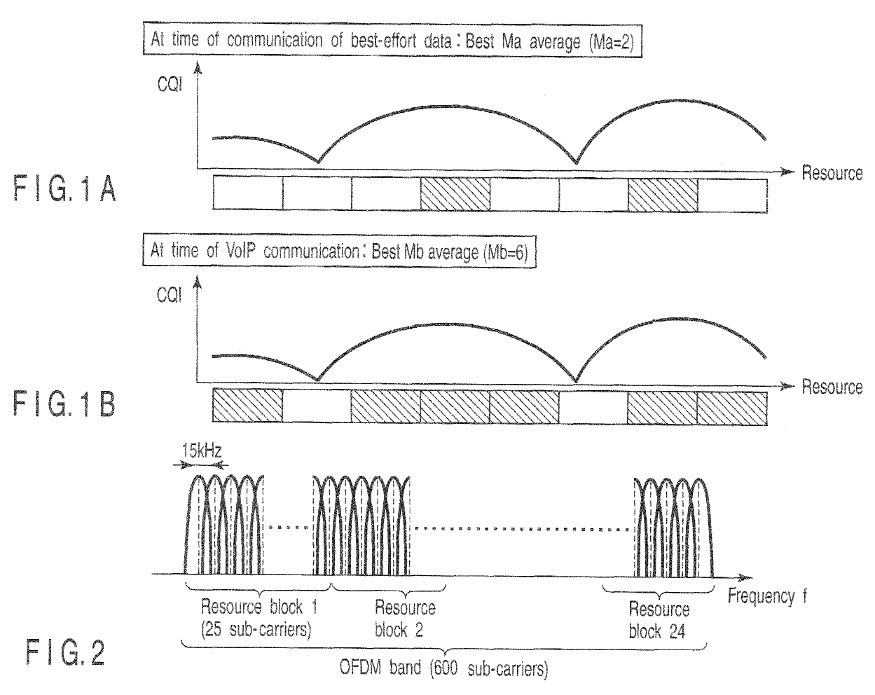

In this case, when performing best-effort data communication (e.g., file downloading), the controller 100 sets M=Ma, as shown in FIG. 1A. When performing low-rate communication with a small delay (e.g., retransmission of a VoIP packet), the controller 100 sets M=Mb (=Ncqi−Ma) for scheduling with a high degree of freedom.

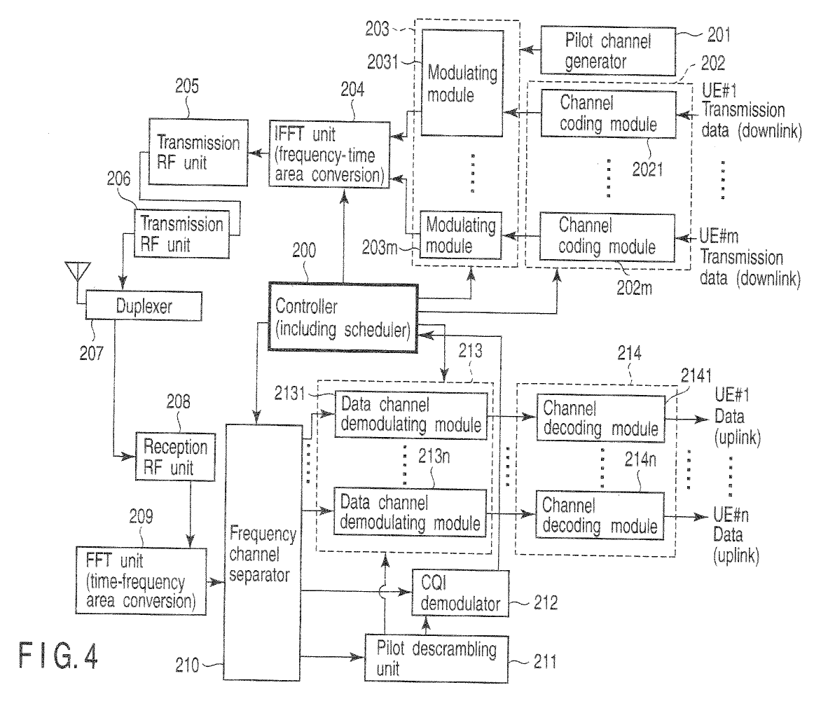

FIG. 4 shows a configuration of a transmitter (base station, i.e., Node B) of the radio communication system according to the first embodiment of the present invention.

A pilot channel generator 201 generates a bit string which is an original signal of a pilot signal transmitted over a pilot channel, processes the bit string with a scrambling code, and outputs the bit string to a modulator 203. A channel coding unit 202 comprises channel coding modules 2021 to 202m. Each of the channel coding modules 2021 to 202m processes a downlink transmission data bit string by channel coding at a channel coding rate designated by a controller 200 and outputs the bit string to the modulator 203.

The modulator 203 comprises modulating modules 2031 to 203m that correspond to the channel coding modules 2021 to 202m, respectively. Each of the modulating modules 2031 to 203m processes the bit strings which are original signals of the pilot signal and the channel-coded downlink transmission data signal, by digital modulation such as the quadrature phase shift keying (QPSK) in the modulation scheme designated by the controller 200, to generate the pilot signal and the transmission data signal.

The generated pilot signal and transmission data signal are assigned to the sub-carriers designated by the controller 200, by a physical resource assigner 204. To “assign the signals to the sub-carriers” means to add a sub-carrier index representing positions on a time axis and a frequency axis, of the sub-carriers in the corresponding resource block, to signals represented by complex numbers.

An inverse fast Fourier transformation (IFFT) unit 205 converts a signal of the frequency area output from the physical resource assigner 204 into a signal of the time area, which is converted into a radio-frequency (RF) signal by a transmission RF unit 206 comprising a digital-to-analog converter, an up-converter, a power amplifier, etc. The RF signal is emitted into space, toward the mobile terminal, via a duplexer 207 and an antenna.

A radio signal transmitted from the mobile terminal is received at the antenna, and output to a reception RF unit 208 via the duplexer 207. The received radio signal is converted into a baseband digital signal by a reception RF unit 208 comprising a down-converter, an analog-to-digital converter, etc.

A fast Fourier transformation (FFT) unit 209 executes fast Fourier transformation of the baseband digital signal and thereby divides the signal of the time area into signals of the frequency area, i.e., signals of the respective sub-carriers. The signals thus divided for the respective sub-carriers are output to a frequency channel separator 210.

The frequency channel separator 210 separates the signals divided for the respective sub-carriers into a pilot signal, a CQI signal and a data signal in accordance with the designation of the controller 200.

The pilot signal is descrambled by a pilot descrambling unit 211, in a descrambling pattern opposite to a scrambling pattern employed in the mobile terminal which transmits the signal to be received by the base station. The descrambling result is output to a CQI demodulator 212 and a data channel demodulator 213.

The CQI demodulator 212 processes the CQI signal output from the frequency channel separator 210 by channel equivalence using the pilot signal descrambled by the pilot descrambling unit 211, and then demodulates the CQI signal. The CQI signal thus demodulated is further subjected to channel decoding by the CQI demodulator 212, and the CQI information transmitted from the mobile terminal is taken from the CQI signal and output to the controller 200.

The data channel demodulator 213 comprises a plurality of data channel demodulating modules 2131 to 213n. The data channel demodulating modules 2131 to 213n process the signals output from the frequency channel separator 210, respectively, by channel equivalence using the pilot signal output from the pilot descrambling unit 211, and then demodulate the signals in the demodulation scheme designated by the controller 200, on the basis of the information output from the controller 200. The data bit strings thus modulated are output to a channel decoding unit 214.

The channel decoding unit 214 comprises channel decoding modules 2141 to 214n which correspond to the data channel demodulating modules 2131 to 213n, respectively. The channel decoding modules 2141 to 214n decode the data bit strings demodulated by the data channel demodulating modules 2131 to 213n, respectively, and obtain uplink data bit strings transmitted from the mobile terminal. The information output from the controller 200 is used for the decoding.

The controller 200 controls all the units of the base station. The controller 200 comprises a scheduling means for controlling transmission of packets to the mobile terminals for each frame, for example, on the basis of feedback information (Ack/Nack of reception response and CQI information) from the mobile terminal, the data amount for each mobile terminal and the degree of priority. In accordance with the designation to the physical resource assigner 204, the controller 200 processes the data for a plurality of mobile terminals by OFDM multiplexing in the same frame.

The controller 200 performs adaptive modulation control for the mobile terminal, and corresponds to the CQI information compressing scheme (e.g., the Best M Average scheme) used by the mobile terminal. Based on the same determination criterion as that in the controller 100, the controller 200 therefore recognizes the number M of CQIs to be notified from the mobile terminal in accordance with the type of service to be executed.

That is, in this case, when performing best-effort data communication (e.g., file downloading), the controller 200 recognizes M=Ma, as shown in FIG. 1A. When performing low-rate communication with a small delay (e.g., retransmission of a VoIP packet), the controller 200 recognizes M=Mb (=Ncqi−Ma) for scheduling with a high degree of freedom.

The operation of the radio communication system having the above configuration will be described next.

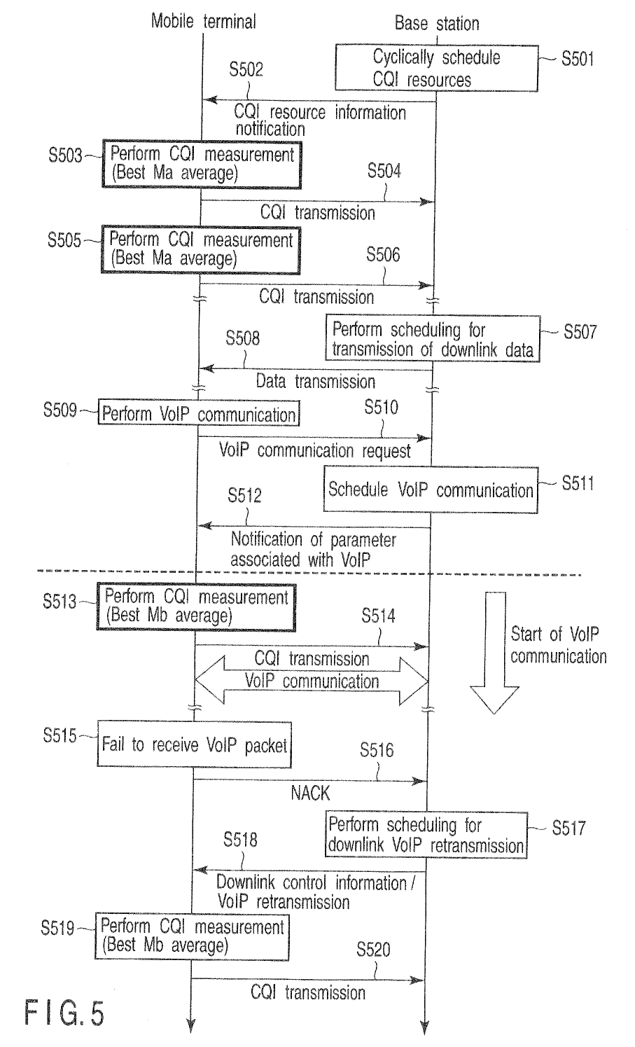

FIG. 5 is a sequence chart associated with CQI transmission to be performed between a mobile terminal and a base station.

When the mobile terminal and the base station start communication, the controller 200 in the base station schedules CQI resource information to be assigned to the mobile terminal (step S501). This processing is executed every time the mobile terminal and the base station start communication.

Note that CQI resource information is information such as a time-frequency resource, CQI format, and modulation scheme which the mobile terminal transmits to the base station. In this case, a time-frequency resource represents a set of sub-carriers for OFDM multiplexing of modulated CQI signals by using times and frequencies. In the base station, the controller 200 controls the transmission system to notify the mobile terminal of CQI resource information based on the above scheduling result via a control channel (step S502).

At this time, the controller 200 recognizes the number M of CQIs to be notified from the mobile terminal as Ma to perform data communication other than default VoIP communication, such as downloading or streaming reception. In this case, when the value of Ma is common to the system and common to the base stations, since the value is predefined information, the base station does not notify the mobile terminal of the information. Note that the base station may notify the mobile terminal of the information via a common channel before communication. Alternatively, the information may be a value unique to the mobile terminal. In this case, the base station notifies the mobile terminal of this value by using the above CQI resource information.

On the other hand, in the mobile terminal, the controller 100 controls the reception system to receive information via the above control channel and acquire the CQI resource information transmitted from the base station from the decoding result obtained by the control channel demodulator 114. At this time, the controller 100 recognizes the number of CQIs to be notified to the base station as Ma in order to perform default best-effort data communication.

In the mobile terminal, in step S503, the controller 100 notifies the frequency channel separator 111 of a channel to be separated on the basis of the resource assignment information of a pilot channel informed via a common control channel before communication. With this operation, the frequency channel separator 111 separates a pilot signal for the Ncqi resource blocks corresponding to the CQI resource information notified from the controller 100, and outputs the signal to the pilot descrambling unit 112.

With this operation, the reception signal quality measuring unit 113 receives the signals of the Ncqi resource blocks designated by the base station and performs CQI measurement for the signals. The controller 100 selects Ma preferable CQI values from the measurement result obtained by the reception signal quality measuring unit 113, and generates the average of the Ma CQI values and items of CQI information indicating values corresponding to the Ma items of resource position information.

In the mobile terminal, in step S504, the controller 100 outputs the CQI information generated in step S503 to the CQI channel generator 103. With this operation, the above CQI information is transmitted to the base station via the CQI channel generator 103 and the transmission system.

Thereafter, the mobile terminal performs CQI measurement in the same manner as in step S503 under the control of the controller 100 in a preset cycle (step S505), and also transmits the measurement result to the base station (step S506). Subsequently, the mobile terminal repeatedly executes CQI measurement and CQI transmission.

When the base station is to transmit downlink data to the mobile terminal at this time, the base station causes the controller 200 to perform scheduling for the transmission of the downlink data to each mobile terminal by using the Ma items of CQI information transmitted from the mobile terminal and information fed back from other mobile terminals (step S507) and control the transmission system to transmit the data together with control information such as a resource block position, sub-frame number, and code rate, which are used for data transmission from the base station to each mobile terminal, via a control channel (step S508).

When the mobile terminal needs to start VoIP communication in response to a user request or the like (step S509), the controller 100 controls the transmission system to issue a request to start VoIP communication to the base station by higher layer communication (step S510).

When the base station receives the above request, the controller 200 schedules uplink resources such as a resource block position, sub-frame number, and code rate, which are used for the transmission of a VoIP packet from the mobile terminal to the base station, and downlink resources such as a resource block position, sub-frame number, and code rate, which are used for the transmission of a VoIP packet from the base station to the mobile terminal (step S511). In the base station, the controller 200 controls the transmission system to notify the mobile terminal of the above resource parameters (assignment resource block positions, sub-frame numbers, code rates, and the like) for uplink/downlink communication via a control channel (step S512). At this time, to perform VoIP communication, the controller 200 recognizes the number M of CQIs to be notified from the mobile terminal as Mb (=Ncqi−Ma).

On the other hand, in the mobile terminal, the controller 100 controls the reception system to receive information via the above control channel and acquire control information transmitted from the base station from the decoding result obtained by the control channel demodulator 114. Note that at this time, in order to perform VoIP communication, the controller 100 recognizes the number of CQIs to be notified to the base station as Mb.

In the mobile terminal, in step S513, the controller 100 notifies the frequency channel separator 111 of a channel to be separated on the basis of the resource assignment information of the pilot channel notified via a common control channel before communication. With this operation, the frequency channel separator 111 separates a pilot signal for Ncqi resource blocks corresponding to the CQI resource information notified from the controller 100, and outputs the signal to the pilot descrambling unit 112.

With this operation, the reception signal quality measuring unit 113 receives the signals of the Ncqi resource blocks designated by the base station and performs CQI measurement for them. The controller 100 then selects Mb preferable CQI values from the measurement result obtained by the reception signal quality measuring unit 113, and generates the average of the Mb CQI values and items of CQI information indicating values corresponding to Mb items of resource position information.

In the mobile terminal, in step S514, the controller 100 outputs the CQI information generated in step S513 to the CQI channel generator 103. With this operation, the above CQI information is transmitted to the base station via the CQI channel generator 103 and the transmission system. Thereafter, VoIP communication is performed, and the mobile terminal performs CQI measurement in the same manner as in step S513 under the control of the controller 100 in a preset cycle, and also transmits the measurement result to the base station. Subsequently, the mobile terminal repeatedly executes CQI measurement and CQI transmission.

Subsequently, when the controller 100 of the mobile terminal detects during VoIP communication that the reception of a VoIP packet has failed, i.e., that the channel decoding unit 116 of the mobile terminal has failed to decode a received VoIP packet, the controller 100 controls the transmission system to transmit a reception failure feedback (NACK) to the base station (step S516).

When the base station receives the above NACK, in order to retransmit the VoIP packet, the controller 200 schedules the packet to be retransmitted to the mobile terminal by using the Mb items of CQI information transmitted from the above mobile terminal and feedback information from other mobile terminals (step S517), and controls the transmission system to transmit data together with control information such as a resource block position, sub-frame number, and code rate used for data transmission from the base station to the mobile terminal via a control channel (step S518).

Subsequently, when the VoIP communication ends, the base station changes the number M of CQIs to be notified from the mobile terminal to the base station from Mb to Ma (=Ncqi−Mb). The mobile terminal also changes the number M from Mb to Ma.

Every time a preset cycle arrives, therefore, the mobile terminal performs CQI measurement in the same manner as in step S513 (step S519) and transmits the measurement result to the base station (step S520) under the control of the controller 100. Thereafter, the mobile terminal repeatedly executes CQI measurement and CQI transmission.

As described above, in the radio communication system having the above configuration, a mobile terminal and a base station switch the number M of CQIs to be notified from the mobile terminal to the base station from Ma to Mb (=Ncqi−Ma) or from Mb to Ma (=Ncqi−Mb) in accordance with the type of communication service. That is, even if the number M of CQIs to be notified from the mobile terminal to the base station is switched in accordance with the type of service, the amount of CQI information does not change as indicated by the following formula (2).

$$⌈ {log}_{2} ( \begin{matrix}Ncqi \\ M\end{matrix} ) ⌉ = ⌈ {log}_{2} ( \begin{matrix}Ncqi \\ Ncqi - M\end{matrix} ) ⌉ \qquad ( 2 )$$

According to the radio communication system having the above configuration, therefore, even if the number of resources for the transmission of CQI values is switched as the type of service is changed, the amount of CQI information does not change. This eliminates the necessity to make an arrangement on the amount of CQI information between the mobile terminal and the base station before a change in the type of service. In addition, the mobile terminal and the base station each can recognize the type of service, it is not necessary to signal the switching of the parameter M between the two stations with a change in the type of service and to change the CQI resource information.

Switching Ma and Mb (Ma<Mb) in accordance with the type of service in this manner will improve the scheduling performance in the controller 200 of the base station. That is, in the case of Ma, the number of resources which can be assigned to the mobile terminal is limited, and only resources with preferable channel qualities are scheduled. This may increase the delay. However, since data can be transmitted at a high rate, the throughput increases. In contrast, in the case of Mb, since the number of resources which can be assigned to the mobile terminal is large, data can be assigned to the mobile terminal with a small delay.

A radio communication system according to the second embodiment of the present invention will be described next. Since the configurations of a receiving station (mobile terminal) and transmitting station (base station) in this radio communication system are the same as those described with reference to FIGS. 2 and 3, a repetitive description will be omitted.

Note, however, that a controller 100 of the mobile terminal according to the second embodiment switches a parameter M in a cycle synchronous with the base station side instead of switching the parameter M in accordance with the type of service as in the first embodiment. For example, the value of the parameter M is alternately and cyclically switched from Ma to Mb (=Ncqi−Ma) and from Mb to Ma (=Ncqi−Mb). Likewise, a controller 200 of the base station according to the second embodiment switches the parameter M in a cycle synchronous with the mobile terminal side.

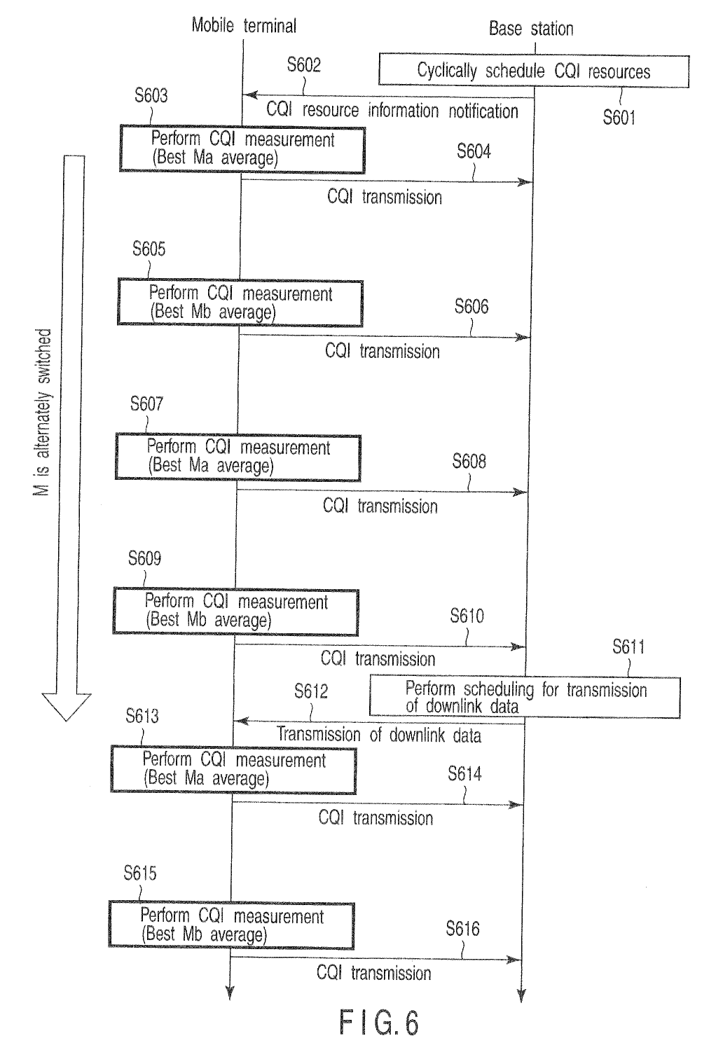

Operation associated with CQI transmission to be performed between the mobile terminal and the base station according to the second embodiment will be described next with reference to the sequence chart shown in FIG. 6.

When the mobile terminal and the base station starts communication, the controller 200 in the base station schedules CQI resource information to be assigned to the mobile terminal (step S601). This processing is executed every time the mobile terminal and the base station start communication.

In the base station, the controller 200 controls the transmission system to notify, via a control channel, the mobile terminal of the CQI resource information based on the above scheduling result and M information indicating that the parameter M is alternately switched (step S602). At this time, the controller 200 has recognized that the initial parameter M starts from Ma.

On the other hand, in the mobile terminal, the controller 100 controls the reception system to receive information via the above control channel and acquire the CQI resource information transmitted from the base station from the decoding result obtained by a control channel demodulator 114. Note that at this time, the controller 100 has recognized that the initial parameter M starts from Ma.

In the mobile terminal, in step S603, the controller 100 notifies a frequency channel separator 111 of a channel to be separated on the basis of the resource assignment information of a pilot channel informed via a common control channel before communication. With this operation, the frequency channel separator 111 separates a pilot signal for the Ncqi resource blocks corresponding to the CQI resource information notified from the controller 100, and outputs the signal to a pilot descrambling unit 112.

With this operation, a reception signal quality measuring unit 113 receives the signals of the Ncqi resource blocks designated by the base station and performs CQI measurement for the signals. The controller 100 selects Ma preferable CQI values from the measurement result obtained by the reception signal quality measuring unit 113, and generates the average of the Ma CQI values and items of CQI information indicating values corresponding to the Ma items of resource position information.

In the mobile terminal, in step S604, the controller 100 outputs the CQI information generated in step S603 to a CQI channel generator 103. With this operation, the above CQI information is transmitted to the base station via the CQI channel generator 103 and the transmission system. When the CQI information is transmitted in this manner, the controller 100 updates the parameter M from Ma to Mb (=Ncqi−Ma). In the base station, when the above CQI information is received, the controller 200 also updates the parameter M from Ma to Mb.

In step S605, therefore, in the mobile terminal, the controller 100 selects Mb preferable CQI values from the measurement result obtained by the reception signal quality measuring unit 113 in the same manner as in step S603, and generates the average of the Mb CQI values and items of CQI information indicating values corresponding to the Mb items of resource position information.

In the mobile terminal, in step S606, the controller 100 outputs the CQI information generated in step S605 to the CQI channel generator 103. With this operation, the above CQI information is transmitted to the base station via the CQI channel generator 103 and the transmission system. When the CQI information is transmitted in this manner, the controller 100 updates the parameter M from Mb to Ma (=Ncqi−Mb). In the base station, when the above CQI information is received, the controller 200 also updates the parameter M from Mb to Ma.

Subsequently, in step S607, the mobile terminal elects Ma preferable CQI values from the measurement result obtained by the reception signal quality measuring unit 113 in the same manner as in step S603, and generates the average of the Ma CQI values and items of CQI information indicating values corresponding to the Ma items of resource position information.

In the mobile terminal, in step S608, the controller 100 outputs the CQI information generated in step S607 to the CQI channel generator 103. With this operation, the above CQI information is transmitted to the base station via the CQI channel generator 103 and the transmission system. When the CQI information is transmitted in this manner, the controller 100 updates the parameter M from Ma to Mb (=Ncqi−Ma). In the base station, when the above CQI information is received, the controller 200 also updates the parameter M from Ma to Mb.

In step S609, therefore, the mobile terminal selects Mb preferable CQI values from the measurement result obtained by the reception signal quality measuring unit 113 in the same manner as in step S605, and generates the average of the Mb CQI values and items of CQI information indicating values corresponding to the Mb items of resource position information.

In the mobile terminal, in step S610, the controller 100 outputs the CQI information generated in step S609 to the CQI channel generator 103. With this operation, the above CQI information is transmitted to the base station via the CQI channel generator 103 and the transmission system. When the CQI information is transmitted in this manner, the controller 100 updates the parameter M from Mb to Ma (=Ncqi−Mb). In the base station, when the above CQI information is received, the controller 200 also updates the parameter M from Mb to Ma.

Assume that, thereafter, the base station has scheduled a resource block position, sub-frame number, code rate, and the like which are used for the transmission of data from the base station to the mobile terminal (step S611). With this operation, in the base station, the controller 200 controls the transmission system to transmit data together with the control information based on the scheduling result via a control channel (step S612). At this time, the controller 200 has received CQI transmission in step S610, and hence has recognized that the CQI information to be transmitted from the mobile terminal next is information corresponding to the parameter Ma. The controller 200 therefore switches the parameter M between Ma and Mb according to a rule independent of data transmission from the base station.

Subsequently, in step S613, the mobile terminal selects Ma preferable CQI values from the measurement result obtained by the reception signal quality measuring unit 113 in the same manner as in steps S603 and S607, and generates the average of the Ma CQI values and items of CQI information indicating values corresponding to Ma items of resource position information.

In the mobile terminal, in step S614, the controller 100 outputs the CQI information generated in step S613 to the CQI channel generator 103. With this operation, the above CQI information is transmitted to the base station via the CQI channel generator 103 and the transmission system. When the CQI information is transmitted in this manner, the controller 100 updates the parameter M from Ma to Mb (=Ncqi−Ma). In the base station, when the above CQI information is received, the controller 200 also updates the parameter M from Ma to Mb.

In step S615, therefore, the mobile terminal selects Mb preferable CQI values from the measurement result obtained by the reception signal quality measuring unit 113 in the same manner as in steps S605 and S609, and generates the average of the Mb CQI values and items of CQI information indicating values corresponding to the Mb items of resource position information.

In the mobile terminal, in step S616, the controller 100 outputs the CQI information generated in step S615 to the CQI channel generator 103. With this operation, the above CQI information is transmitted to the base station via the CQI channel generator 103 and the transmission system. When the CQI information is transmitted in this manner, the controller 100 updates the parameter M from Mb to Ma (=Ncqi−Mb). In the base station, when the above CQI information is received, the controller 200 also updates the parameter M from Mb to Ma.

As described above, in the radio communication system having the above configuration, the mobile terminal and the base station synchronously switch the number M of CQIs to be notified from the mobile terminal to the base station from Ma to Mb (=Ncqi−Ma) or from Mb to Ma (=Ncqi−Mb). With this configuration, even if the number M of CQIs to be notified from the mobile terminal to the base station is switched, the amount of CQI information does not change as indicated by the formula (2).

According to the radio communication system having the above configuration, therefore, even if the number of resources for the transmission of CQI values is switched, the amount of CQI information does not change. This eliminates the necessity to make an arrangement on the amount of CQI information between the mobile terminal and the base station before a change in the type of service.

In the above embodiment, the controller 200 of the base station determines to alternately switch the value of the parameter M. However, setting a parameter M switching rule unique to the system and letting a mobile terminal and a base station know the rule in advance makes it unnecessary for the base station to notify the mobile terminal.

In the above embodiment, the value of the parameter M is alternately switched between Ma and Mb (=Ncqi−Ma). However, it suffices to continuously use each value N times or to continuously use one of the values N1 times, then continuously use the other value N2 times, and switch the values again. Even with this switching rule, letting a mobile terminal and a base station know the rule as the one unique to the system in advance makes it unnecessary for the base station to notify the mobile terminal.

A radio communication system according to the third embodiment of the present invention will be described next. Since the configurations of a receiving station (mobile terminal) and transmitting station (base station) in this radio communication system are the same as those described with reference to FIGS. 2 and 3, a repetitive description will be omitted.

Note, however, that a controller 100 of the mobile terminal according to the third embodiment switches a parameter M in accordance with flag notification from the base station side instead of switching the parameter M in accordance with the type of service as in the first embodiment. For example, the value of the parameter M is switched from Ma to Mb (=Ncqi−Ma) or from Mb to Ma (=Ncqi−Mb) during only a preset interval.

A controller 200 of the base station according to the third embodiment, therefore, monitors at least one of the type of service, the moving speed of the mobile terminal, a receiving environment, the overload state of the base station, and the like, and performs the above flag notification to the mobile terminal in accordance with the monitoring result. Note that the base station can estimate the moving speed of the mobile terminal by measuring the Doppler shift of an uplink signal from the mobile terminal to the base station. In addition, the mobile terminal can estimate the moving speed of the mobile terminal by performing measuring using a device such as a GPS or measuring the Doppler shift of a downlink signal from the base station to the mobile terminal. When the mobile terminal obtains its moving speed, it is necessary to transmit the corresponding information to the base station by using a control channel or the like.

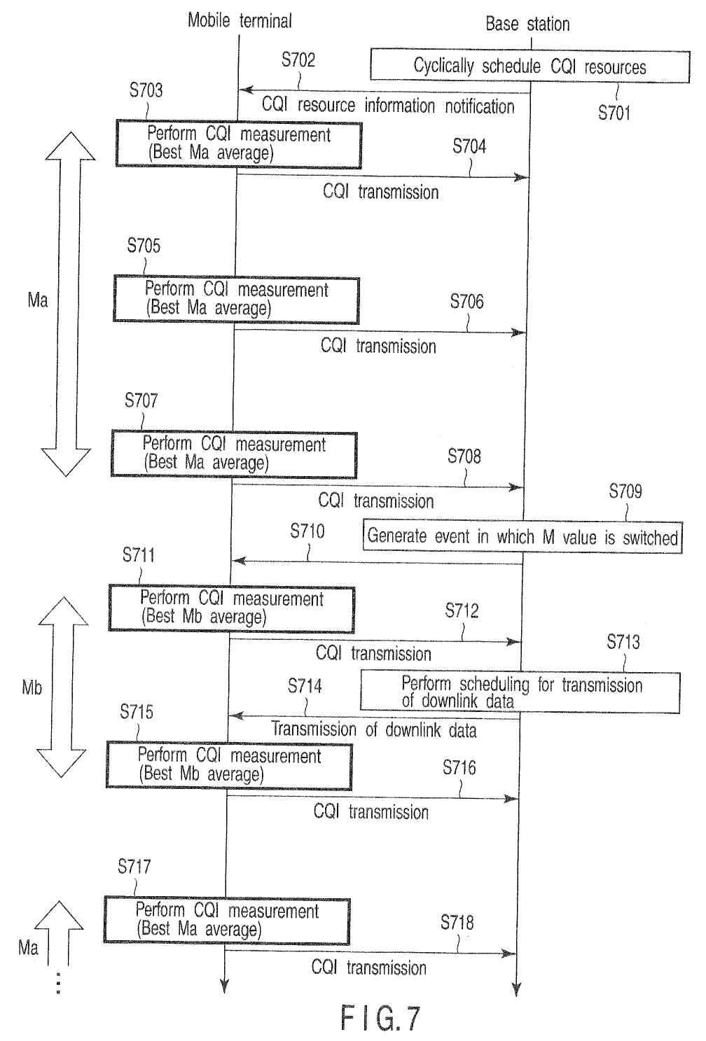

Operation associated with CQI transmission to be performed between the mobile terminal and the base station according to the third embodiment will be described next with reference to the sequence chart shown in FIG. 7.

First of all, when the mobile terminal and the base station start communication, the controller 200 in the base station schedules CQI resource information to be assigned to the mobile terminal (step S701). This processing is executed every time the mobile terminal and the base station start communication.

In the base station, the controller 200 controls the transmission system to notify, via a control channel, the mobile terminal of the CQI resource information based on the above scheduling result (step S702). At this time, the controller 200 has recognized that the initial parameter M starts from Ma.

On the other hand, in the mobile terminal, the controller 100 controls the reception system to receive information via the above control channel and acquire the CQI resource information transmitted from the base station from the decoding result obtained by a control channel demodulator 114. Note that at this time, the controller 100 has recognized that an initial parameter M starts from Ma.

In the mobile terminal, in step S703, the controller 100 notifies a frequency channel separator 111 of a channel to be separated on the basis of the resource assignment information of a pilot channel informed via a common control channel before communication. With this operation, the frequency channel separator 111 separates a pilot signal for the Ncqi resource blocks corresponding to the CQI resource information notified from the controller 100, and outputs the signal to a pilot descrambling unit 112.

With this operation, a reception signal quality measuring unit 113 receives the signals of the Ncqi resource blocks designated by the base station and performs CQI measurement for the signals. The controller 100 selects Ma preferable CQI values from the measurement result obtained by the reception signal quality measuring unit 113, and generates the average of the Ma CQI values and items of CQI information indicating values corresponding to the Ma items of resource position information.

In the mobile terminal, in step S704, the controller 100 outputs the CQI information generated in step S703 to a CQI channel generator 103. With this operation, the above CQI information is transmitted to the base station via the CQI channel generator 103 and the transmission system.

Subsequently, in step S705, the mobile terminal selects Ma preferable CQI values from the measurement result obtained by the reception signal quality measuring unit 113 in the same manner as in step S703, and generates the average of the Ma CQI values and items of CQI information indicating values corresponding to Ma items of resource position information.

In step S706, the mobile terminal transmits the above CQI information to the base station via the CQI channel generator 103 and the transmission system in the same manner as in step S704. The mobile terminal then repeats the same processing in steps S707 and S708.

Assume that the base station has detected, in step S709, the occurrence of an event in which the parameter M is switched from Ma to Mb (=Ncqi−Ma). The occurrence of such an event includes, for example, a case in which the type of communication service has changed to a preset type, the moving speed of the mobile terminal has changed to a threshold or more, a value indicating the state of a receiving environment has changed to a threshold or more, or the base station has been overloaded. The controller 200 of the base station monitors them in step S709 to detect the occurrence of an event.

Upon detecting the occurrence of an event, the controller 200 of the base station executes step S710. That is, the controller 200 controls the transmission system to transmit, via a control channel, information indicating that the parameter M is switched from Ma to Mb (=Ncqi−Ma) and a flag indicating the number (N) of times of continuation of the parameter M. Note that the number N of times of continuation can be set to a value corresponding to the above monitoring result. In the following description, for example, N is set to “2”.

On the other hand, in the mobile terminal, the controller 100 controls the reception system to receive information via the above control channel and acquire the flag transmitted from the base station from the decoding result obtained by the control channel demodulator 114. The controller 100 analyzes the flag and recognizes that the base station changes the parameter M from Ma to Mb. The controller 100 also recognizes that the parameter M is continued N times and CQI information is transmitted. The controller 100 resets a counter n to “0”.

In the mobile terminal, in step S711, the controller 100 notifies the frequency channel separator 111 of a channel to be separated on the basis of the resource assignment information of a pilot channel informed via a common control channel before communication. With this operation, the frequency channel separator 111 separates a pilot signal for the Ncqi resource blocks corresponding to the CQI resource information notified from the controller 100, and outputs the signal to the pilot descrambling unit 112.

With this operation, the reception signal quality measuring unit 113 receives the signals of the Ncqi resource blocks designated by the base station and performs CQI measurement for the signals. The controller 100 selects Mb preferable CQI values from the measurement result obtained by the reception signal quality measuring unit 113, and generates the average of the Mb CQI values and items of CQI information indicating values corresponding to the Mb items of resource position information.

In the mobile terminal, in step S712, the controller 100 outputs the CQI information generated in step S711 to the CQI channel generator 103. With this operation, the above CQI information is transmitted to the base station via the CQI channel generator 103 and the transmission system. When CQI information is transmitted in this manner, the controller 100 increments a counter n, and determines whether the value of the counter n becomes equal to N notified from the base station via the flag. In this case, since this is the first transmission, the parameter M is continued to be Mb and is not updated to Ma.

Assume that, thereafter, the base station has scheduled a resource block position, sub-frame number, code rate, and the like which are used for the transmission of data from the base station to the mobile terminal (step S713). With this operation, in the base station, the controller 200 controls the transmission system to transmit data together with the control information based on the scheduling result via a control channel (step S714). At this time, the controller 200 has recognized that the CQI information to be transmitted from the mobile terminal next is information corresponding to the parameter Mb, because flag notification has been performed in step S710. As described above, since the optimal M parameter has been selected at each time point, an improvement in the accuracy of scheduling can be expected when the base station performs downlink data transmission scheduling.

In step S715, the mobile terminal then selects Mb preferable CQI values from the measurement result obtained by the reception signal quality measuring unit 113 in the same manner as in step S711, and generates the average of the Mb CQI values and items of CQI information indicating values corresponding to Mb items of resource position information.

In the mobile terminal, in step S716, the controller 100 outputs the CQI information generated in step S715 to the CQI channel generator 103. With this operation, the above CQI information is transmitted to the base station via the CQI channel generator 103 and the transmission system. When the CQI information is transmitted in this manner, the controller 100 increments the counter n, and determines whether the value of the counter n becomes equal to N notified from the base station via the flag. In this case, since this is the second transmission, the value of the counter n coincides with N, the parameter M is updated to Ma.

Subsequently, in step S717, the mobile terminal selects Ma preferable CQI values from the measurement result obtained by the reception signal quality measuring unit 113 in the same manner as in step S703, and generates the average of the Ma CQI values and items of CQI information indicating values corresponding to Ma items of resource position information.

In the mobile terminal, in step S718, the controller 100 outputs the CQI information generated in step S717 to the CQI channel generator 103. With this operation, the above CQI information is transmitted to the base station via the CQI channel generator 103 and the transmission system. Subsequently, as in steps S709 and S710, CQI information is generated and transmitted by using the parameter Ma until an event occurs.

As described above, in the radio communication system having the above configuration, the base station monitors the occurrence of an event, and switches the number M of CQIs to be notified from the mobile terminal to the base station from Ma to Mb (=Ncqi−Ma) or from Mb to Ma (=Ncqi−Mb) in accordance with the monitoring result. With this configuration, even if the number M of CQIs to be notified from the mobile terminal to the base station is switched, the amount of CQI information does not change as indicated by the formula (2).

According to the radio communication system having the above configuration, therefore, even if the number M of resources for the transmission of CQI values is switched, the amount of CQI information does not change. This eliminates the necessity to make an arrangement on the amount of CQI information between the mobile terminal and the base station before a change in the parameter M.

In the above embodiment, the number N of times of continuation of a switched parameter is notified via a flag notified from the base station to the mobile terminal. However, it suffices to impose a temporal limitation instead of using the number of times of transmission of CQI information from the mobile terminal to the base station as a restoration condition. That is, the base station notifies the mobile terminal of a time limit T via the above flag.

Upon receiving the above flag, the controller 100 of the mobile terminal switches the parameter Mb and starts a timer t. Subsequently, the parameter Mb is used until the time limit T expires. When the time limit T expires, the parameter is restored to the initial parameter Ma. In the base station, the controller 200 also uses the parameter Mb until the time limit T expires after flag notification. When the time limit T expires, the controller 200 uses the parameter Ma. Such control can also establish matching with the parameter M between the mobile terminal and the base station. In addition, the amount of CQI information does not change. Therefore, the same effects as those described above can be obtained.

A radio communication system according to the fourth embodiment of the present invention will be described next. Since the configurations of a receiving station (mobile terminal) and transmitting station (base station) in this radio communication system are the same as those described with reference to FIGS. 2 and 3, a repetitive description will be omitted.

Note, however, that a controller 100 of the mobile terminal according to the fourth embodiment switches a parameter M upon flag notification from the mobile terminal side instead of switching the parameter M in accordance with the type of service as in the first embodiment. For example, the controller 100 switches the value of the parameter M from Ma to Mb (=Ncqi−Ma) or from Mb to Ma (=Ncqi−Mb) only during a preset interval. The controller 100 of the mobile terminal according to the fourth embodiment, therefore, monitors at least one of the type of service, the moving speed of the mobile terminal, a receiving environment, and the like, and notifies the base station of the above flag in accordance with the monitoring result.

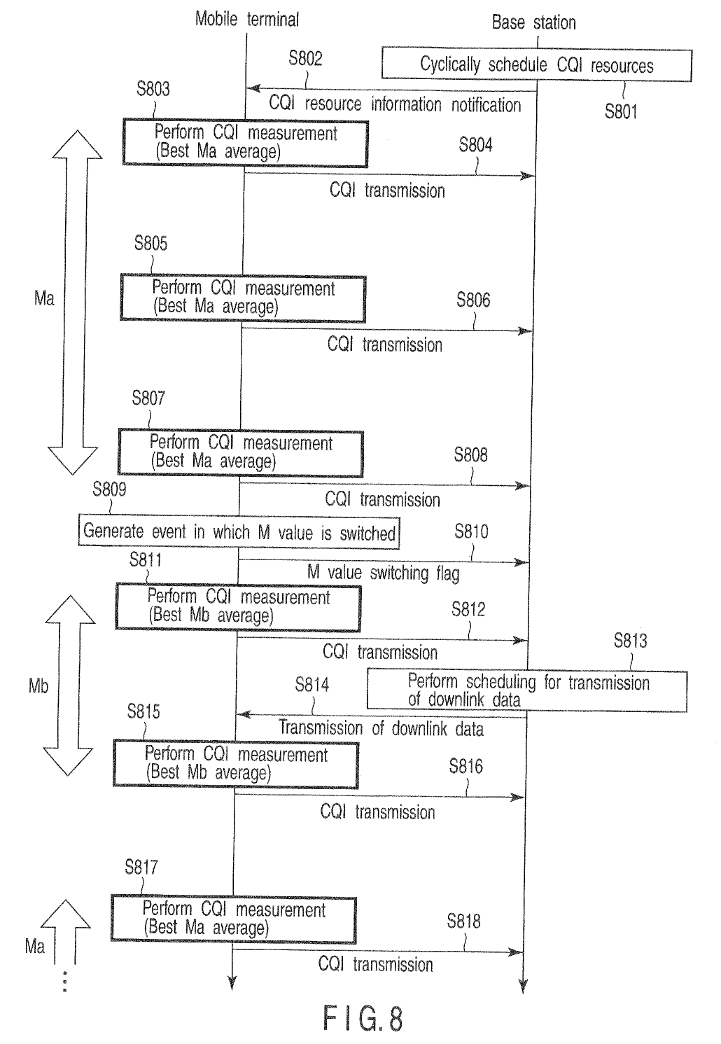

Operation associated with CQI transmission to be performed between the mobile terminal and the base station according to the fourth embodiment will be described next with reference to the sequence chart shown in FIG. 8.

When the mobile terminal and the base station start communication, a controller 200 in the base station schedules CQI resource information to be assigned to the mobile terminal (step S801). This processing is executed every time the mobile terminal and the base station start communication.

In the base station, the controller 200 controls the transmission system to notify, via a control channel, the mobile terminal of the CQI resource information based on the above scheduling result (step S802). At this time, the controller 200 has recognized that the initial parameter M starts from Ma.

On the other hand, in the mobile terminal, the controller 100 controls the reception system to receive information via the above control channel and acquire the CQI resource information transmitted from the base station from the decoding result obtained by a control channel demodulator 114. Note that at this time, the controller 100 has recognized that the initial parameter M starts from Ma.

In the mobile terminal, in step S803, the controller 100 notifies a frequency channel separator 111 of a channel to be separated on the basis of the resource assignment information of a pilot channel informed via a common control channel before communication. With this operation, the frequency channel separator 111 separates a pilot signal for the Ncqi resource blocks corresponding to the CQI resource information notified from the controller 100, and outputs the signal to a pilot descrambling unit 112.

With this operation, a reception signal quality measuring unit 113 receives the signals of the Ncqi resource blocks designated by the base station and performs CQI measurement for the signals. The controller 100 selects Ma preferable CQI values from the measurement result obtained by the reception signal quality measuring unit 113, and generates the average of the Ma CQI values and items of CQI information indicating values corresponding to the Ma items of resource position information.

In the mobile terminal, in step S804, the controller 100 outputs the CQI information generated in step S803 to a CQI channel generator 103. With this operation, the above CQI information is transmitted to the base station via the CQI channel generator 103 and the transmission system.

Thereafter, in step S805, the mobile terminal selects Ma preferable CQI values from the measurement result obtained by the reception signal quality measuring unit 113 in the same manner as in step S803, and generates the average of the Ma CQI values and items of CQI information indicating values corresponding to the Ma items of resource position information.

In step S806, the mobile terminal transmits the above CQI information to the base station via the CQI channel generator 103 and the transmission system in the same manner as in step S804. The mobile terminal repeats the same processing in steps S807 and S808.

Assume that the mobile terminal has detected, in step S809, the occurrence of an event in which the parameter M is switched from Ma to Mb (=Ncqi−Ma). The occurrence of such an event includes, for example, a case in which the type of communication service has changed to a preset type, the moving speed of the mobile terminal has changed to a threshold or more, or a value indicating the state of a receiving environment has changed to a threshold or more. The controller 100 of the mobile terminal monitors them in step S809 to detect the occurrence of an event.

Upon detecting the occurrence of an event, the controller 100 of the mobile terminal executes step S810. That is, the controller 100 controls the transmission system to transmit, via a control channel, information indicating that the parameter M is switched from Ma to Mb (=Ncqi−Ma) and a flag indicating the number (N) of times of continuation of the parameter M. Note that the number N of times of continuation can be set to a value corresponding to the above monitoring result. In the following description, for example, N is set to “2”. In addition, the controller 100 resets a counter n to “0”.

On the other hand, in the base station, the controller 200 controls the reception system to receive information via the above control channel and acquire the flag transmitted from the mobile terminal from the decoding result obtained by a demodulator 213. The controller 200 analyzes the flag and recognizes that the mobile terminal changes the parameter M from Ma to Mb. The controller 200 also recognizes that the parameter M is continued N times and CQI information is transmitted.

In the mobile terminal, in step S811, the controller 100 notifies the frequency channel separator 111 of a channel to be separated on the basis of the resource assignment information of a pilot channel informed via a common control channel before communication. With this operation, the frequency channel separator 111 separates a pilot signal for the Ncqi resource blocks corresponding to the CQI resource information notified from the controller 100, and outputs the signal to the pilot descrambling unit 112.

With this operation, the reception signal quality measuring unit 113 receives the signals of the Ncqi resource blocks designated by the base station and performs CQI measurement for the signals. The controller 100 selects Mb preferable CQI values from the measurement result obtained by the reception signal quality measuring unit 113, and generates the average of the Mb CQI values and items of CQI information indicating values corresponding to the Mb items of resource position information.

In the mobile terminal, in step S812, the controller 100 outputs the CQI information generated in step S811 to the CQI channel generator 103. With this operation, the above CQI information is transmitted to the base station via the CQI channel generator 103 and the transmission system. When transmitting the CQI information in this manner, the controller 100 increments the counter n and determines whether the value of the counter n becomes equal to N notified to the base station via the flag. In this case, since this is the first transmission, the parameter M is continued to be Mb and is not updated to Ma.

Assume that, thereafter, the base station has scheduled a resource block position, sub-frame number, code rate, and the like which are used for the transmission of data from the base station to the mobile terminal (step S813). With this operation, in the base station, the controller 200 controls the transmission system to transmit data together with the control information based on the scheduling result via a control channel (step S814). At this time, the controller 200 has recognized that the CQI information to be transmitted from the mobile terminal next is information corresponding to the parameter Mb, because the flag has been received in step S810. As described above, since the optimal M parameter has been selected at each time point, an improvement in the accuracy of scheduling can be expected when the base station performs downlink data transmission scheduling.

In step S815, the mobile terminal then selects Mb preferable CQI values from the measurement result obtained by the reception signal quality measuring unit 113 in the same manner as in step S811, and generates the average of the Mb CQI values and items of CQI information indicating values corresponding to Mb items of resource position information.

In the mobile terminal, in step S816, the controller 100 outputs the CQI information generated in step S815 to the CQI channel generator 103. With this operation, the above CQI information is transmitted to the base station via the CQI channel generator 103 and the transmission system. When the CQI information is transmitted in this manner, the controller 100 increments the counter n, and determines whether the value of the counter n becomes equal to N notified from the base station via the flag. In this case, since this is the second transmission, the value of the counter n coincides with N, the parameter M is updated to Ma.

Subsequently, in step S817, the mobile terminal selects Ma preferable CQI values from the measurement result obtained by the reception signal quality measuring unit 113 in the same manner as in step S803, and generates the average of the Ma CQI values and items of CQI information indicating values corresponding to Ma items of resource position information.

In the mobile terminal, in step S818, the controller 100 outputs the CQI information generated in step S817 to the CQI channel generator 103. With this operation, the above CQI information is transmitted to the base station via the CQI channel generator 103 and the transmission system. Subsequently, as in steps S809 and S810, CQI information is generated and transmitted by using the parameter Ma until an event occurs.

As described above, in the radio communication system having the above configuration, the mobile terminal monitors the occurrence of an event, and switches the number M of CQIs to be notified from the mobile terminal to the base station from Ma to Mb (=Ncqi−Ma) or from Mb to Ma (=Ncqi−Mb) in accordance with the monitoring result. With this configuration, even if the number M of CQIs to be notified from the mobile terminal to the base station is switched, the amount of CQI information does not change as indicated by the formula (2).

According to the radio communication system having the above configuration, therefore, even if the number M of resources for the transmission of CQI values is switched, the amount of CQI information does not change. This eliminates the necessity to make an arrangement on the amount of CQI information between the mobile terminal and the base station before a change in the parameter M.

In the above embodiment, the number N of times of continuation of a switched parameter is notified via a flag notified from the mobile terminal to the base station. However, it suffices to impose a temporal limitation instead of using the number of times of transmission of CQI information from the mobile terminal to the base station as a restoration condition. That is, the mobile terminal notifies the base station of a time limit T via the above flag. Upon transmitting the flag, the controller 100 of the mobile terminal switches the parameter Mb and starts a timer t. Subsequently, the parameter Mb is used until the time limit T expires. When the time limit T expires, the parameter is restored to the initial parameter Ma. In the base station, upon receiving the flag, the controller 200 also uses the parameter Mb until the time limit T expires. When the time limit T expires, the controller 200 uses the parameter Ma. Such control can also establish matching with the parameter M between the mobile terminal and the base station. In addition, the amount of CQI information does not change. Therefore, the same effects as those described above can be obtained.

A radio communication system according to the fifth embodiment of the present invention will be described next. Since the configurations of a receiving station (mobile terminal) and transmitting station (base station) in this radio communication system are the same as those described with reference to FIGS. 2 and 3, a repetitive description will be omitted.

A controller 200 of the base station according to the fifth embodiment, however, performs scheduling in response to the occurrence of an event in the base station as a trigger instead of defining the following CQI transmission by scheduling CQI resource information once at the time of the start of communication as in step S501 in the first embodiment. When, for example, a transmission traffic addressed to the mobile terminal is generated, the controller 200 of the base station according to the fifth embodiment therefore performs the above scheduling in response to the occurrence of the traffic as a trigger.

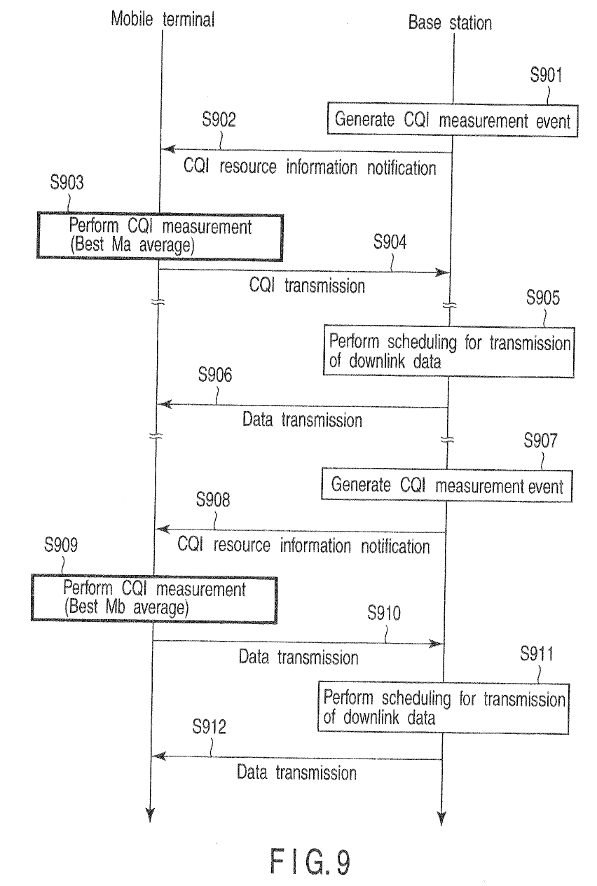

The operation of the radio communication system having the above configuration will be described next. FIG. 9 is a sequence chart associated with CQI transmission to be performed between a mobile terminal and a base station.

First of all, when the base station needs to acquire CQI information upon occurrence of a transmission traffic addressed to the mobile terminal, the controller 200 determines that an event has occurred. The controller 200 then schedules CQI resource information assigned to the mobile terminal and determines whether to change the parameter M to Ma or Mb (step S901). Assume that the controller 200 has selected Ma in this case.

In the base station, the controller 200 controls the transmission system to notify the mobile terminal of the CQI resource information based on the above scheduling result and the parameter M via a control channel (step S902).

On the other hand, in the mobile terminal, a controller 100 controls the reception system to receive information via the above control channel and acquire the CQI resource information and parameter M transmitted from the base station from the decoding result obtained by a control channel demodulator 114. With this operation, the controller 100 recognizes, by referring to the acquired parameter M, that the number of CQIs to be notified to the base station is Ma.

In the mobile terminal, in step S903, the controller 100 notifies a frequency channel separator 111 of a channel to be separated on the basis of the resource assignment information of a pilot channel informed via a common control channel before communication. With this operation, the frequency channel separator 111 separates a pilot signal for the Ncqi resource blocks corresponding to the CQI resource information notified from the controller 100, and outputs the signal to a pilot descrambling unit 112.

With this operation, a reception signal quality measuring unit 113 receives the signals of the Ncqi resource blocks designated by the base station and performs CQI measurement for the signals. The controller 100 selects Ma preferable CQI values from the measurement result obtained by the reception signal quality measuring unit 113, and generates the average of the Ma CQI values and items of CQI information indicating values corresponding to the Ma items of resource position information.

In the mobile terminal, in step S904, the controller 100 outputs the CQI information generated in step S903 to the CQI channel generator 103. With this operation, the above CQI information is transmitted to the base station via the CQI channel generator 103 and the transmission system.

As in this embodiment, according to a trigger based scheme of performing CQI measurement in response to the occurrence of some kind of event, CQI measurement is basically performed only when triggered. However, it suffices to repeatedly execute CQI measurement and CQI transmission by a predetermined number of times or for a predetermined interval per trigger. In this case, the mobile terminal performs CQI measurement and transmits the measurement result to the base station in the same manner as in step S903 by a predetermined number of times or for a predetermined interval in a preset cycle under the control of the controller 100. Subsequently, the mobile terminal repeatedly executes CQI measurement and CQI transmission.

When the base station is to transmit downlink data to the mobile terminal at this time, the base station causes the controller 200 to perform scheduling for the transmission of the downlink data to each mobile terminal by using the Ma items of CQI information transmitted from the mobile terminal and information fed back from other mobile terminals (step S905) and control the transmission system to transmit the data together with control information such as a resource block position, sub-frame number, and code rate, which are used for data transmission from the base station to each mobile terminal, via a control channel (step S906).

When the base station needs to acquire CQI information upon occurrence of another transmission traffic addressed to the mobile terminal, the controller 200 determines that an event has occurred.

The controller 200 then schedules CQI resource information assigned to the mobile terminal and determines whether to change the parameter M to Ma or Mb (step S907). Assume that the controller 200 has selected Mb in this case.

In the base station, the controller 200 controls the transmission system to notify the mobile terminal of the CQI resource information based on the above scheduling result and the parameter M via a control channel (step S908).

On the other hand, in the mobile terminal, a controller 100 controls the reception system to receive information via the above control channel and acquire the CQI resource information and parameter M transmitted from the base station from the decoding result obtained by a control channel demodulator 114. With this operation, the controller 100 recognizes, by referring to the acquired parameter M, that the number of CQIs to be notified to the base station is Mb.

In the mobile terminal, in step S909, the controller 100 notifies the frequency channel separator 111 of a channel to be separated on the basis of the resource assignment information of the pilot channel informed via a common control channel before communication. With this operation, the frequency channel separator 111 separates a pilot signal for the Ncqi resource blocks corresponding to the CQI resource information notified from the controller 100, and outputs the signal to the pilot descrambling unit 112.

With this operation, the reception signal quality measuring unit 113 receives the signals of the Ncqi resource blocks designated by the base station and performs CQI measurement for the signals. The controller 100 selects Mb preferable CQI values from the measurement result obtained by the reception signal quality measuring unit 113, and generates the average of the Mb CQI values and items of CQI information indicating values corresponding to the Mb items of resource position information.

In the mobile terminal, in step S910, the controller 100 outputs the CQI information generated in step S909 to the CQI channel generator 103. With this operation, the above CQI information is transmitted to the base station via the CQI channel generator 103 and the transmission system (step S910).

When the base station is to transmit downlink data to the mobile terminal at this time, the base station causes the controller 200 to perform scheduling for the transmission of the downlink data to each mobile terminal by using the Mb items of CQI information transmitted from the mobile terminal and information fed back from other mobile terminals (step S911) and control the transmission system to transmit the data together with control information such as a resource block position, sub-frame number, and code rate, which are used for data transmission from the base station to each mobile terminal, via a control channel (step S912).

As described above, in the radio communication system having the above configuration, the base station monitors the occurrence of an event, and switches the number M of CQIs to be notified from the mobile terminal to the base station from Ma to Mb (=Ncqi−Ma) or from Mb to Ma (=Ncqi−Mb) in accordance with the monitoring result. With this configuration, even if the number M of CQIs to be notified from the mobile terminal to the base station is switched, the amount of CQI information does not change as indicated by the formula (2).

According to the radio communication system having the above configuration, therefore, even if the number of resources for the transmission of CQI values is switched, the amount of CQI information does not change. This eliminates the necessity to prepare a plurality of CQI channel formats corresponding to changes in the parameter M.

In the above embodiment, the parameter M is updated in response to the occurrence of an event in the base station as a trigger. However, even if the parameter M is updated in response to the occurrence of an event in the mobile terminal as a trigger, the amount of CQI information does not change. Therefore, the same effects as those described above can be obtained.

Note that the present invention is not limited to the above embodiments, and constituent elements can be variously modified and embodied at the execution stage within the spirit and scope of the invention. Various inventions can be formed by proper combinations of a plurality of constituent elements disclosed in the above embodiments. For example, several constituent elements may be omitted from all the constituent elements in each embodiment. In addition, constituent elements of the different embodiments may be combined as needed.

For example, in the above embodiments, the parameter M is switched from Ma to Mb (=Ncqi−Ma) or from Mb to Ma (=Ncqi−Mb). However, the present invention is not limited to these two types of parameters. For example, preparing {m1, m2, m3, m4, N−m1, N−m2, N−m3, N−m4} as a set of M values can halve the variation of information amounts even with finer control of the parameter M.

Needless to say, the present invention can also be variously modified within a scope which does not depart from the gist of the present invention.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A radio apparatus, executing radio communication with a base station device accommodated in a network, comprising:
a measurement unit measuring reception signal qualities of preset N radio resources;
a detection unit detecting that a preset communication service is started; and
a notification unit notifying the base station device of identification information of M (M<N) radio resources, of N radio resources, from which preferable reception signal qualities are measured, on the basis of reception signal qualities of the N radio resources measured by the measurement unit, and, when the detection unit detects the start of the communication service, notifying the base station device of identification information of N−M radio resources, of the N radio resources, from which preferable reception signal qualities are measured, on the basis of the reception signal qualities of the N radio resources measured by the measurement unit.

2. A radio apparatus, executing radio communication with a base station device accommodated in a network, comprising:
a measurement unit measuring reception signal qualities of preset N radio resources;
a detection unit detecting that a preset communication service is started; and
a notification unit repeatedly executing a first process of notifying the base station device of identification information of M (M<N) radio resources, of N radio resources, from which preferable reception signal qualities are measured, on the basis of reception signal qualities of the N radio resources measured by the measurement unit and a second process of notifying the base station device of identification information of N−M radio resources, of the N radio resources, from which preferable reception signal qualities are measured, on the basis of the reception signal qualities of the N radio resources measured by the measurement unit.

3. The apparatus according to claim 2, wherein the notification unit switches and executes the first process and the second process every time the measurement unit executes measurement.

4. A radio apparatus, executing radio communication with a base station device accommodated in a network, comprising:
a measurement unit measuring reception signal qualities of preset N radio resources;
a detection unit detecting that a preset event has occurred; and
a notification unit notifying the base station device of identification information of M (M<N) radio resources, of N radio resources, from which preferable reception signal qualities are measured, on the basis of reception signal qualities of the N radio resources measured by the measurement unit, and, when the detection unit detects occurrence of the event, notifying the base station device of identification information of N−M radio resources, of the N radio resources, from which preferable reception signal qualities are measured, on the basis of the reception signal qualities of the N radio resources measured by the measurement unit.

5. The apparatus according to claim 4, wherein the detection unit detects, as occurrence of an event, a case in which a type of communication service is changed to a preset type.

6. The apparatus according to claim 4, wherein the detection unit detects, as occurrence of an event, a case in which a moving speed exceeds a preset threshold.

7. The apparatus according to claim 4, wherein the detection unit detects, as occurrence of an event, a case in which a value representing a state of a receiving environment exceeds a preset threshold.

8. The apparatus according to claim 4, wherein the detection unit detects, as occurrence of an event, a case in which the base station device is overloaded.

9. The apparatus according to claim 4, wherein the communication unit notifies the base station device of identification information of N−M radio resources, of N radio resources, from which preferable reception signal qualities are measured, on the basis of reception signal qualities of the N radio resources measured by the measurement unit, by a preset number of times of continuation when the detection unit detects the occurrence of the event, and then notifies the base station device of identification information of M radio resources, of the N radio resources, from which preferable reception signal qualities are measured, on the basis of the reception signal qualities of the N radio resource measured by the measurement unit.

10. The apparatus according to claim 9, further comprising a reception unit receiving a notification of the number of times of continuation from the base station device.

11. A radio communication method of executing radio communication with a base station device accommodated in a network, comprising:
measuring reception signal qualities of preset N radio resources;
detecting that a preset communication service is started; and
notifying the base station device of identification information of M (M<N) radio resources, of N radio resources, from which preferable reception signal qualities are measured, on the basis of reception signal qualities of the N radio resources measured by the measuring, and, when the detecting detects the start of the communication service, notifying the base station device of identification information of N−M radio resources, of the N radio resources, from which preferable reception signal qualities are measured, on the basis of the reception signal qualities of the N radio resources measured by the measuring.

12. A radio communication method of executing radio communication with a base station device accommodated in a network, comprising:
measuring reception signal qualities of preset N radio resources;
detecting that a preset communication service is started; and
repeatedly executing a first process of notifying the base station device of identification information of M (M<N) radio resources, of N radio resources, from which preferable reception signal qualities are measured, on the basis of reception signal qualities of the N radio resources measured by the measuring and a second process of notifying the base station device of identification information of N−M radio resources, of the N radio resources, from which preferable reception signal qualities are measured, on the basis of the reception signal qualities of the N radio resources measured by the measuring.

13. The method according to claim 12, wherein the notifying switches and executes the first process and the second process every time the measuring executes measurement.

14. A method of executing radio communication with a base station device accommodated in a network, comprising:
measuring reception signal qualities of preset N radio resources;
detecting that a preset event has occurred; and
notifying the base station device of identification information of M (M<N) radio resources, of N radio resources, from which preferable reception signal qualities are measured, on the basis of reception signal qualities of the N radio resources measured by the measuring, and, when the detecting detects occurrence of the event, notifying the base station device of identification information of N−M radio resources, of the N radio resources, from which preferable reception signal qualities are measured, on the basis of the reception signal qualities of the N radio resources measured by the measuring.

15. The method according to claim 14, wherein the detecting detects, as occurrence of an event, a case in which a type of communication service is changed to a preset type.

16. The method according to claim 14, wherein the detecting detects, as occurrence of an event, a case in which a moving speed exceeds a preset threshold.

17. The method according to claim 14, wherein the detecting detects, as occurrence of an event, a case in which a value representing a state of a receiving environment exceeds a preset threshold.

18. The method according to claim 14, wherein the detecting detects, as occurrence of an event, a case in which the base station device is overloaded.

19. The method according to claim 14, wherein the communicating notifies the base station device of identification information of N−M radio resources, of N radio resources, from which preferable reception signal qualities are measured, on the basis of reception signal qualities of the N radio resources measured by the measuring, by a preset number of times of continuation when the detecting detects the occurrence of the event, and then notifies the base station device of identification information of M radio resources, of the N radio resources, from which preferable reception signal qualities are measured, on the basis of the reception signal qualities of the N radio resource measured by the measuring.

20. The method according to claim 19, further comprising receiving a notification of the number of times of continuation from the base station device.
